(19) United States
(12) Patent Application Publication
(10) Pub. No.: US 2011/0142503 A1
(43) Pub. Date: Jun. 16, 2011

(54) CONDUCTIVE ROLLER AND ELECTROPHOTOGRAPHIC APPARATUS EMPLOYING THE SAME

(76) Inventors: Yusuke Tanio, Kobe-shi (JP); Hideyuki Okuyama, Kobe-shi (JP)

(21) Appl. No.: 12/907,558

(22) Filed: Oct. 19, 2010

(30) Foreign Application Priority Data
Dec. 10, 2009 (JP) 2009-280820

(51) Int. Cl. G03G 15/16

(52) U.S. Cl. 399/313

(57) ABSTRACT

The conductive roller according to the present invention includes a roller body made of a thermoplastic elastomer composition supplied with conductivity having an outer cylinder constituting an outer peripheral surface of the roller body, an inner cylinder, having an outer diameter smaller than the inner diameter of the outer cylinder, concentrically arranged in the outer cylinder, and a plurality of platelike coupling portions reaching the inner periphery of the outer cylinder from the outer periphery of the inner cylinder, wherein a plurality hollow portions separated from one another by the coupling portions are provided between the outer periphery of the inner cylinder and the inner periphery of the outer cylinder, and each coupling portion is arranged to intersect with a plane passing through the central axes of the outer cylinder and the inner cylinder so that adjacent hollow portions separated from each other by the coupling portion overlap with each other on the plane inwardly and outwardly in the radial direction in a section of the roller body in a direction orthogonal to the axial direction.

### BACKGROUND OF THE INVENTION

1. Field of the Invention

The present invention relates to a conductive roller built into an electrophotographic apparatus such as a laser printer to be employed as a transfer roller or the like transferring a toner image formed on the surface of a photosensitive body or an image carrier of the electrophotographic apparatus to the surface of a paper (including a plastic film or the like: this also applies to the following description) and an electrophotographic apparatus including the conductive roller built thereinto as a transfer roller.

2. Description of Related Art

An electrophotographic apparatus such as a laser printer, an electrostatic copier, a plain paper facsimile or a composite machine thereof uniformly charges the surface of a photosensitive body and exposes the same for forming an electrostatic latent image corresponding to an image on the surface (a charging step→an exposing step). Next, the electrostatic latent image is developed into a toner image by selectively bonding a previously charged toner thereto (a developing step). Next, the toner image is transferred to the surface of a paper (a transfer step) and further fixed (a fixing step), thereby the image is formed on the surface of the paper.

In the transfer step, the electrophotographic apparatus may simply transfer the toner image formed on the surface of the photosensitive body directly to the surface of the paper, or may temporarily transfer the toner image to the surface of an image carrier and thereafter retransfer the same to the surface of the paper.

In the charging step included in the aforementioned steps, a process of charging the toner and a process of bonding the toner to the electrostatic latent image in the developing step, the transfer step and a cleaning step of removing the toner remaining on the surface of the photosensitive body or the image carrier after transferring the toner image to the surface of the paper, a conductive or semiconductive roller (may hereinafter be generically referred to as a “conductive roller”) is widely employed.

For example, an image can be formed on the surface of a paper by feeding the paper through a space between the photosensitive body or the image carrier and the conductive roller as a transfer roller while applying a prescribed voltage therebetween thereby transferring a toner image formed on the surface of the photosensitive body or the image carrier to the surface of the paper by static electric force between the surface of the photosensitive body or the image carrier and the transfer roller.

In general, a roller prepared by inserting a shaft into the center of a roller body made of a porous body of crosslinked (vulcanized) rubber and supplied with conductivity by blending an electronically conductive filler of conductive carbon or the like into the rubber or employing rubber having ion conductivity as the rubber itself has been employed as the transfer roller. In recent years, a technique of preparing the roller body from an easily recyclable thermoplastic elastomer composition in place of the vulcanized rubber has also been examined.

The roller body of the transfer roller must be so flexible that the same is excellently compressively deformed in the radial direction by contact pressure when brought into contact with the surface of the photosensitive body or the image carrier to be contactable with the surface of the photosensitive body or the image carrier with a prescribed nip width through the paper. Thus, the paper can be closely brought into contact with the surface of the photosensitive body or the image carrier, and the toner image can be excellently transferred from the surface of the photosensitive body or the image carrier to the surface of the paper.

However, particularly a nonporous roller body made of a thermoplastic elastomer composition is apt to be insufficient in flexibility as compared with that of the porous body of vulcanized rubber.

Each of Patent Document 1 (Japanese Unexamined Utility Model Publication No. 6-28868 (1994)), Patent Document 2 (Japanese Unexamined Patent Publication No. 10-299762 (1998)), Patent Document 3 (Japanese Unexamined Patent Publication No. 2008-139691) and Patent Document 4 (Japanese Unexamined Patent Publication No. 2008-298855) describes a technique of providing a plurality of hollow portions in a roller body made of an elastic material such as the vulcanized rubber or the thermoplastic elastomer composition along the axial direction of a shaft inserted into the center of the roller body and the roller body, to surround the shaft.

According to this structure, the nonporous roller body made of the thermoplastic elastomer composition can conceivably be improved in flexibility. When pressure is applied to the roller body due to the contact with the photosensitive body or the image carrier, the hollow portions are deformed in a crushed manner to assist the outer peripheral surface of the roller body in compressive deformation inward in the radial direction along the surface of the photosensitive body or the image carrier, thereby improving the flexibility of the roller body.

Due to the structure of the conductive roller, however, the hollow portions cannot be continuously formed over the entire periphery of the shaft. In other words, solid regions must be provided on a plurality of portions of the roller body in the circumferential direction, in order to integrally form the roller body and the shaft while matching the central axes thereof with each other.

In general, the solid regions are arranged to reach the outer peripheral surface of the roller body from that of the shaft along a plane passing through the central axis of the shaft, as described in each of the Patent Documents 1 to 4.

In the conventional conductive roller, however, the flexibility of the roller body itself varies with the regions corresponding to the solid portions and the remaining regions including the hollow portions. When the conductive roller is used as a transfer roller, therefore, contact states (the contact pressure, the nip width etc.) with the photosensitive body or the image carrier may fluctuate between the regions, to cause nonuniformity resulting from the fluctuation in the image formed on the surface of the paper. The nonuniformity is easily caused particularly under a low-temperature condition reducing the flexibility of the thermoplastic elastomer composition.

### SUMMARY OF THE INVENTION

An object of the present invention is to provide a conductive roller including a roller body having excellent flexibility which is generally constant over the entire periphery in the circumferential direction with no possibility of causing nonuniformity or the like in an image formed on the surface of a paper particularly under a low-temperature condition when the conductive roller is used as a transfer roller, for example, and an electrophotographic apparatus including the conductive roller built thereinto as a transfer roller or the like.

The conductive roller according to the present invention includes a roller body made of a thermoplastic elastomer composition supplied with conductivity having an outer cylinder constituting an outer peripheral surface of the roller body, an inner cylinder, having an outer diameter smaller than the inner diameter of the outer cylinder, concentrically arranged in the outer cylinder, and a plurality of platelike coupling portions reaching the inner periphery of the outer cylinder from the outer periphery of the inner cylinder, wherein a plurality hollow portions separated from one another by the coupling portions are provided between the outer periphery of the inner cylinder and the inner periphery of the outer cylinder, and each coupling portion is arranged to intersect with a plane passing through the central axes of the outer cylinder and the inner cylinder so that adjacent hollow portions separated from each other by the coupling portion overlap with each other on the plane inwardly and outwardly in the radial direction in a section of the roller body in a direction orthogonal to the axial direction.

According to the present invention, the flexibility of the roller body can be improved as a whole, due to the function of the hollow portions provided in the roller body.

According to the present invention, further, each coupling portion separating the corresponding hollow portions from each other is arranged to intersect with the plane passing through the central axes of the outer cylinder and the inner cylinder. Whereby the adjacent hollow portions separated from each other by the coupling portion can overlap with each other on the plane inwardly and outwardly in the radial direction. In the roller body, therefore, the hollow portions are necessarily present over the entire periphery thereof. Consequently, the flexibility of the roller body can also be rendered generally constant as a whole over the periphery in the circumferential direction due to the action of the hollow portions.

Preferably, the thermoplastic elastomer composition forming the roller body is supplied with conductivity by dispersing:

a crosslinked substance of at least one rubber component selected from a group consisting of diene rubber and ethylene propylene rubber; and

an ion-conductive resin antistatic agent into a resin matrix containing a styrene-based thermoplastic elastomer and polypropylene.

Thus, the roller body having the complex shape can be easily manufactured with excellent productivity by extrusion molding or the like. Further, the recyclability of the formed roller body can also be improved.

Preferably, the ion-conductive resin antistatic agent contains at least an ion-conductive elastomer and an ion-conductive salt.

Thus, uniform conductivity can be supplied to the overall roller body.

The present invention also provides an electrophotographic apparatus including the conductive roller according to the present invention. The electrophotographic apparatus can form an excellent image on the surface of a paper with no nonuniformity or the like particularly under a low-temperature condition, due to the function of the conductive roller.

According to the present invention, a conductive roller including a roller body having excellent flexibility which is generally constant over the entire periphery in the circumferential direction with no possibility of causing nonuniformity or the like in an image formed on the surface of a paper particularly under a low-temperature condition when the conductive roller is used as a transfer roller, for example, and an electrophotographic apparatus including the conductive roller built thereinto as a transfer roller or the like can be provided.

The foregoing and other objects, features and effects of the present invention will become more apparent from the following detailed description of the embodiments with reference to the attached drawings.

### BRIEF DESCRIPTION OF THE DRAWINGS

FIG. 1 is a perspective view showing the whole of a conductive roller according to an embodiment of the present invention.

FIG. 2 is a sectional view of a roller body included in the conductive roller shown in FIG. 1.

FIG. 3 is a sectional view partially showing the roller body in an enlarged manner.

FIG. 4 is a perspective view showing a mouthpiece of a die employed for forming the roller body by extrusion molding.

FIG. 5 is a perspective view illustrating a step of forming the roller body by extrusion molding with the die having the mouthpiece shown in FIG. 4.

FIG. 6 is a schematic configuration diagram showing an electrophotographic apparatus according to an embodiment of the present invention.

### DETAILED DESCRIPTION OF PREFERRED EMBODIMENTS

### Thermoplastic Elastomer Composition

The roller body of the conductive roller according to the present invention is preferably made of a thermoplastic elastomer composition supplied with conductivity by dispersing:

a crosslinked substance of at least one rubber component selected from a group consisting of diene rubber and ethylene propylene rubber; and

an ion-conductive resin antistatic agent into a resin matrix containing a styrene-based thermoplastic elastomer and polypropylene, as hereinabove described.

The thermoplastic elastomer composition can be prepared by dispersing the crosslinked substance of the rubber component into the resin matrix by dynamic crosslinking of kneading a mixture containing the resin matrix and the rubber component not yet crosslinked while heating the same thereby crosslinking the rubber component and thereafter blending the ion-conductive resin antistatic agent, for example.

The styrene-based thermoplastic elastomer is preferably prepared from a hydrogenated styrene-based thermoplastic elastomer. The hydrogenated styrene-based thermoplastic elastomer has low hardness and excellent flexibility due to saturation of a double bond by hydrogenation, and is excellent in durability. Therefore, occurrence of flattening or the like can be efficiently suppressed, and the roller body as well as the conductive roller can be improved in durability.

Further, the hydrogenated styrene-based thermoplastic elastomer contains no double bond, thereby having no possibility of inhibiting the dynamic crosslinking of the rubber component. In addition, the hydrogenated styrene-based thermoplastic elastomer itself is not crosslinked, whereby desired plasticity and flexibility can be supplied to the thermoplastic elastomer composition after the dynamic crosslinking.

The hydrogenated styrene-based thermoplastic elastomer is preferably prepared from a hydrogenated substance of at least one styrene-based thermoplastic elastomer selected from a group consisting of a styrene-butadiene-styrene copolymer (SBS), a styrene-isoprene-styrene copolymer (SIS), a styrene-ethylene/propylene copolymer (SEP), a styrene-ethylene/propylene-styrene copolymer (SEPS), a styrene-ethylene/butylenes-styrene copolymer (SEBS) and a styrene-ethylene-ethylene/propylene-styrene copolymer (SEEPS). In particular, a hydrogenated substance of SEEPS is preferable.

Polypropylene improves workability of the thermoplastic elastomer composition in extrusion molding. The polypropylene can be prepared not less than one or two of various polypropylene materials such as homopolymer type polypropylene prepared by polymerizing only propylene, random or block copolymer type polyethylene prepared by copolymerizing a small amount of another olefin such as ethylene in order to improve low-temperature brittleness or the like of the homopolymer type polypropylene and the like.

Diene rubber can be prepared from natural rubber (NR), isoprene rubber (IR), butadiene rubber (BR), styrene-butadiene copolymer rubber (SBR), chloroprene rubber (CR) or acrylonitrile-butadiene copolymer rubber (NR), for example. Ethylene propylene rubber can be prepared from ethylene-propylene copolymer rubber (EPM) or ethylene-propylene-diene copolymer rubber (EPDM), for example. As the rubber component, any one of the rubber materials may be singly used, or not less than two of the rubber materials may be combined with each other.

Particularly EPDM is preferable. The EPDM has a main chain consisting of saturated hydrocarbon and contains no double bond, and hence the main chain is hardly cut even if the EPDM is exposed to an environment such as a high-concentration ozone atmosphere or photoirradiation including ultraviolet radiation over a long period of time. Therefore, the EPDM can improve ozone resistance, resistance to ultraviolet radiation, heat resistance etc. of the roller body. The EPDM, preferably singly employed, may be combined with another rubber component. In this case, the ratio of the EPDM in the overall rubber component is preferably not less than 50 mass %, particularly preferably not less than 80 mass %.

When the rubber component is dynamically crosslinked as described above, a crosslinking agent for crosslinking the rubber component is blended into the mixture of the rubber component and the resin matrix. The crosslinking agent is preferably prepared from a resin crosslinking agent.

The resin crosslinking agent is synthetic resin capable of crosslinking the rubber component by heating or the like, causes no bloom dissimilarly to a general sulfur crosslinking system (a system employing both sulfur and a vulcanization accelerator or the like). Further, the resin crosslinking agent is capable of preventing the crosslinked rubber component from compression set and reduction in mechanical characteristics and improving the durability thereof.

According to the resin crosslinking agent, the crosslinking time can be reduced as compared with the sulfur crosslinking system. When the mixture of the components including the rubber component is heated, kneaded and dynamically crosslinked in an extruder, therefore, the dynamic crosslinking can be sufficiently progressed in a short period when the mixture remains in the extruder.

The resin crosslinking agent is preferably prepared from at least one material selected from a group consisting of phenolic resin, melamine-formaldehyde resin, a triazine-formaldehyde condensate and hexamethoxymethyl-melamine resin, and particularly preferably prepared from the phenolic resin.

The phenolic resin is preferably synthesized by reaction between phenol such as phenol, alkylphenol, cresol, xylenol or resorcin and aldehyde such as formaldehyde, acetaldehyde or furfural. The phenolic resin can also be prepared from halogenated phenolic resin containing at least one halogen atom bonded to an aldehyde unit of the phenolic resin.

In particular, alkylphenol-formaldehyde resin obtained by reaction between alkylphenol in which an alkyl group is bonded to the ortho or para position of benzene and formaldehyde is preferable since the same is excellent in compatibility with the rubber component and abundant in reactivity so that the crosslinking can be started in a relatively early stage.

The alkyl group of the alkylphenol-formaldehyde resin is preferably prepared from an alkyl group having a carbon number of 1 to 10, such as a methyl group, an ethyl group, a propyl group or a butyl group, for example. A halogenated substance of the alkylphenol-formaldehyde resin is also preferably employed.

Further, modified alkylphenol resin prepared by addition-condensing p-tert-butylphenol sulfide and aldehyde or alkylphenol-sulfide resin can also be used as the resin crosslinking agent.

In order to properly perform the dynamic crosslinking, a crosslinking assistant (a crosslinking activator) may be blended into the mixture of the resin matrix and the rubber component. The crosslinking assistant can be prepared from a metallic compound such as zinc oxide or zinc carbonate, for example, and zinc oxide (zinc white) is particularly preferable.

A softener may be blended into the mixture of the resin matrix and the rubber component. The softener renders the mixture easily kneadable when the rubber component is dynamically crosslinked for more finely and homogeneously dispersing the crosslinked substance of the rubber component into the resin matrix, and improves the flexibility of the roller body.

The softener is preferably prepared from oil or a plasticizer. The oil is preferably prepared from at least one material selected from a group consisting of mineral oil such as paraffinic oil, naphthenic oil or aromatic oil, synthetic oil consisting of a hydrocarbon-based oligomer and process oil. The synthetic oil is preferably prepared from at least one material selected from a group consisting of an oligomer of α-olefin, an oligomer of butene and an amorphous oligomer of ethylene and α-olefin, for example.

The plasticizer is preferably prepared from at least one material selected from a group consisting of dioctyl phthalate (DOP), dibutyl phthalate (DEP), dioctyl sebacate and dioctyl adipate, for example.

Particularly paraffinic oil is preferable, and any paraffinic oil prepared by refining paraffinic base oil of mineral oil (crude oil) can be used as the paraffinic oil.

The ion-conductive elastomer constituting the ion-conductive resin antistatic agent can be prepared from not less than one or two block copolymers containing at least polyether, more specifically, an ethylene oxide-propylene oxide copolymer (may hereinafter be abbreviated as an “EO-PO copolymer”) and an ethylene oxide-propylene oxide-allyl glycidyl ether copolymer (may hereinafter be abbreviated as an “EO-PO-AGE copolymer”).

The copolymer stabilizes ions derived from the ion-conductive salt due to the function of ethylene oxide (EO) units and propylene oxide (PO) units, particularly the EO units, contained in the molecules thereby supplying excellent ion conductivity to the roller body and reducing electrical resistance.

In the EO-PO copolymer, the content of the EO units is preferably not less than 55 mole %, particularly preferably not less than 65 mole %, and preferably not more than 95 mole %, particularly preferably not more than 92 mole %.

If the content of the EO units is less than the above range, the effect of stabilizing the ions derived from the ion-conductive salt due to the function of the EO units thereby supplying excellent ion conductivity to the roller body may not be sufficiently attained. If the content of the EO units exceeds the above range, on the other hand, the EO units are so easily crystallized and hence the effect of stabilizing the ions derived from the ion-conductive salt due to the function of the EO units thereby supplying excellent ion conductivity to the roller body may not be sufficiently attained as well.

In the EO-PO-AGE copolymer, the content of the EO units is preferably not less than 55 mole %, particularly preferably not less than 65 mole %, and preferably not more than 95 mole %, particularly preferably not more than 92 mole %.

If the content of the EO units is less than the above range, the effect of stabilizing the ions derived from the ion-conductive salt due to the function of the EO units thereby supplying excellent ion conductivity to the roller body may not be sufficiently attained. If the content of the EO units exceeds the above range, on the other hand, the EO units are so easily crystallized and hence the effect of stabilizing the ions derived from the ion-conductive salt due to the function of the EO units thereby supplying excellent ion conductivity to the roller body may not be sufficiently attained as well.

In the EO-PO-AGE copolymer, the content of allyl glycidyl ether (AGE) units containing allyl groups functioning as crosslinking functional groups when crosslinking the rubber component with a peroxidic crosslinking agent described later is preferably not less than 1 mole %, particularly preferably not less than 2 mole %, and preferably not more than 10 mole %, particularly preferably not more than 8 mole %.

If the content of the AGE units is less than the above range, the EC-PO-AGE copolymer can be so inferiorly crosslinked that the copolymer not yet crosslinked or insufficiently crosslinked may bleed or bloom on the surface of the roller body and the ion-conductive salt may easily bloom or bleed on the surface of the roller body following the bleeding or the blooming, to contaminate a photosensitive body or a toner.

If the content of the AGE units exceeds the above range, on the other hand, the crosslink density may be so excessively increased that tensile strength, fatigue characteristics, resistance to fatigue from flexing etc. of the EO-PO-AGE copolymer may be reduced.

The number-average molecular weight Mn of each of the EO-PO copolymer and the EO-PO-AGE copolymer is preferably not less than 10000, particularly preferably not less than 50000. If the number-average molecular weight Mn is less than the above range, the copolymer may bleed or bloom on the surface of the roller body and the ion-conductive salt may easily bloom or bleed on the surface of the roller body following the bleeding or the blooming, to contaminate the photosensitive body or the toner.

The ion-conductive salt is preferably prepared from a salt of anions having fluoro groups and sulfonyl groups and cations in view of the effect of supplying excellent ion-conductivity to the roller body.

The anions having fluoro groups and sulfonyl groups can be prepared from fluoroalkyl sulfonic acid ions, bis(fluoroalkyl sulfonyl) imide ions or tris(fluoroalkylsulfonyl) methide ions, for example.

The cations can be prepared from ions of an alkaline metal such as sodium, lithium or potassium, ions of a group II element such as beryllium, magnesium, calcium, strontium or barium, ions of a transition element, cations of an amphoteric element, quaternary ammonium ions or imidazolium cations, for example. In particular, a lithium salt combined with lithium ions is preferable.

The lithium salt is preferably prepared from at least one material selected from a group consisting of CF₃SO₃Li, C₄F₉SO₃Li, (CF₃SO₂)₂NLi, (C₂F₅SO₂)₂NLi, C₄F₉SO₂)(CF₃SO₂)NLi, (FSO₂C₆F₄)(CF₃SO₂)NLi, (C₈F₁₇SO₂)(CF₃SO₂)NLi, (CF₃CH₂OSO₂)₂NLi, (CF₃CF₂CH₂OSO₂)₂NLi, (HCF₂CF₂CH₂OSO₂)₂NLi, [(CF₃)₂CHOSO₂]₂Nli, (CF₃SO₂)₃CLi and (CF₃CH₂OSO₂)₃CLi.

In particular, CF₃SO₃Li (lithium trifluoromethanesulfonate) and (CF₃SO₂)₂NLi [bis(trifluoromethanesulfonyl) imide lithium] are preferable in view of the effect of supplying excellent ion conductivity to the roller body, and lithium trifluoromethanesulfonate is particularly preferable.

The ion-conductive salt is blended into the resin matrix having the crosslinked rubber component dispersed thereinto, in the state of the ion-conductive resin antistatic agent previously dispersed into the ion-conductive elastomer. Thus, the ion-conductive salt can be finely dispersed into the resin matrix in a state ubiquitous in the ion-conductive elastomer.

Therefore, the ion conductivity of the roller body can be further improved, and the photosensitive body or the toner can be prevented from contamination resulting from a bloom of the ion-conductive salt by inhibiting the ion-conductive salt from moving to the surface of the roller body when an electric field is continuously applied to the conductive roller, for example.

A solubilizer may be further blended into the mixture of the resin matrix and the ion-conductive antistatic agent.

The solubilizer finely disperses the ion-conductive elastomer into the resin matrix. Further the solubilizer finely disperses the ion-conductive salt into the resin matrix in the state ubiquitous in the ion-conductive elastomer on the basis of excellent affinity for the ion-conductive elastomer.

The solubilizer can be prepared from at least one material selected from a group consisting of an ethylene-acrylic ester-maleic anhydride copolymer and an ethylene-acrylic ester-glycidyl methacrylate copolymer.

In the ethylene-acrylic ester-maleic anhydride copolymer and/or the ethylene-acrylic ester-glycidyl methacrylate copolymer, the content of acrylic ester units is preferably not less than 0.1 mass %, more preferably not less than 1 mass %, particularly preferably not less than 3 mass %, and preferably not more than 30 mass %, more preferably not more than 20 mass %, particularly preferably not more than 15 mass %. The content of maleic anhydride units is preferably not less than 0.05 mass %, more preferably not less than 0.1 mass %, particularly preferably not less than 1 mass %, and preferably not more than 20 mass %, more preferably not more than 15 mass %, particularly preferably not more than 10 mass %. The content of glycidyl methacrylate units is preferably not less than 0.05 mass %, more preferably not less than 0.1 mass %, particularly preferably not less than 1 mass %, and preferably not more than 20 mass %, more preferably not more than 15 mass %, particularly preferably not more than 10 mass %.

The acrylic ester can be prepared from not less than one or two of methyl acrylate, ethyl acrylate, propyl acrylate, butyl acrylate, 2-ethylhexyl acrylate, methyl methacrylate, ethyl methacrylate, propyl methacrylate, butyl methacrylate and 2-ethylhexyl methacrylate, for example.

A peroxidic crosslinking agent may further be blended into the mixture of the resin matrix and the ion-conductive antistatic agent.

The peroxidic crosslinking agent functions to dynamically crosslink the ion-conductive elastomer in the resin matrix.

The peroxidic crosslinking agent is preferably prepared from at least one material selected from a group consisting of benzoyl peroxide, 1,1-bis(tert-butyl peroxy)-3,3,5-trimethyl cyclohexane, 2,5-dimethyl-2,5-di(benzoyl peroxy) hexane, di(tert-butyl peroxy) diisopropyl benzene, 1,4-bis[(tert-butyl) peroxy isopropyl]benzene, di(tert-butylperoxy)benzoate, tert-butyl peroxy benzoate, dicumyl peroxide, tert-butylcumyl peroxide, 2,5-dimethyl-2,5-di(tert-butylperoxy) hexane, ditert-butyl peroxide and 2,5-dimethyl-2,5-di(tert-butyl peroxy)-3-hexene. In particular, di(tert-butyl peroxy) diisopropyl benzene is preferable.

A crosslinking assistant may be employed along with the peroxidic crosslinking agent. The crosslinking assistant crosslinks itself and also crosslinks with the ion-conductive elastomer, to bring the overall mixture into a high polymer state. The crosslink density can be improved by co-crosslinking with the crosslinking assistant.

The crosslinking assistant is preferably prepared from at least one material selected from a group consisting of a metal salt of methacrylic acid or acrylic acid, methacrylic ester, an aromatic vinyl compound, a heterocyclic vinyl compound, an allyl compound, a polyfunctional polymer utilizing a functional group of 1,2-polybutadiene and dioxime.

More specifically, at least one material selected from a group consisting of triallyl isocyanurate (TAIC), triallyl cyanurate (TAC), trimethylolpropane trimethacrylate (TMPT), ethylene glycol dimethacrylate (EDMA), p-quinone dioxime, p,p′-dibenzoyl quinone dioxime and N,N′-m-phenylene bismaleimide is preferable. In particular, N,N′-m-phenylene bismaleimide is preferable.

A filler may be further blended into the thermoplastic elastomer composition containing the components. The filler functions for improving the mechanical strength of the roller body.

The filler is preferably prepared from at least one material selected from a group consisting of silica, carbon black, clay, talc, calcium carbonate, dibasic lead phosphite (DLP), basic magnesium carbonate and alumina, calcium carbonate and/or carbon black.

At least one additive selected from a group consisting of a foaming agent, an age resistor, an antioxidant, a UV absorber, a lubricant, a pigment, an antistatic agent, a flame retardant, a neutralizer, a nucleator and a bubbling inhibitor may be blended into the thermoplastic elastomer composition.

The blending ratios of the components can be arbitrarily set.

For example, the blending ratio of the resin matrix containing the styrene-based thermoplastic elastomer and polypropylene is preferably not less than 10 parts by mass, particularly preferably not less than 20 parts by mass and preferably not more than 100 parts by mass, particularly preferably not less than 75 parts by mass with respect to 100 parts by mass of the rubber component.

If the blending ratio of the resin matrix is less than the above range, the quantity of the resin matrix as the thermoplastic component is so excessively small that it may not be possible to supply excellent thermoplasticity to the thermoplastic elastomer composition. Further, it may not be possible to excellently disperse the crosslinked substance of the rubber component and the ion-conductive resin antistatic agent into the resin matrix either.

If the blending ratio of the resin matrix exceeds the above range, on the other hand, the quantity of the crosslinked substance of the rubber component is so relatively reduced that it may not be possible to supply excellent rubber elasticity to the roller body. Further, the quantity of the ion-conductive resin antistatic agent is so relatively reduced that it may not be possible to supply excellent ion conductivity to the roller body either.

When the styrene-based thermoplastic elastomer and polypropylene are employed together as the resin matrix, the blending ratio of the resin matrix corresponds to the total blending ratio of the two materials.

In the resin matrix prepared from the styrene-based thermoplastic elastomer and polypropylene, the blending ratio of polypropylene with respect to 100 parts by mass of the styrene-based thermoplastic elastomer is preferably not less than 10 parts by mass, particularly preferably not less than 30 parts by mass, and preferably not more than 100 parts by mass, particularly preferably not more than 50 parts by mass.

If the blending ratio of polypropylene is less than the above range, it may not be possible to sufficiently attain the aforementioned effect of the thermoplastic elastomer composition improving the workability in the extrusion molding resulting from the blending of the polypropylene. If the blending ratio of polypropylene exceeds the above range, on the other hand, the quantity of the styrene-based thermoplastic elastomer is so relatively reduced that the flexibility of the roller body may be reduced.

The blending ratio of the resin crosslinking agent is preferably not less than 2 parts by mass, particularly preferably not less than 5 parts by mass, and preferably not more than 20 parts by mass, particularly preferably not more than 15 parts by mass with respect to 100 parts by mass of the rubber component.

If the blending ratio of the resin crosslinking agent is less than the above range, the rubber component is so insufficiently crosslinked that it may not be possible to supply excellent mechanical characteristics and durability to the roller body. If the blending ratio of the resin crosslinking agent exceeds the above range, on the other hand, the rubber component is so excessively hardened that the flexibility of the roller body may be reduced.

The blending ratio of the crosslinking assistant (the crosslinking activator) is preferably not less than 0.01 parts by mass, particularly preferably not less than 0.1 parts by mass and preferably not more than 10 parts by mass, particularly preferably not more than 5 parts by mass with respect to 100 parts by mass of the rubber component.

The blending ratio of the softener is preferably not less than 50 parts by mass, particularly preferably not less than 80 parts by mass, and preferably not more than 250 parts by mass, particularly preferably not more than 200 parts by mass with respect to 100 parts by mass of the rubber component.

If the blending ratio of the softener is less than the above range, it may not be possible to sufficiently attain the aforementioned effect resulting from the blending of the softener. If the blending ratio of the softener exceeds the above range, on the other hand, not only no further effect of adding the softener is attained but also an excess part of the softener may bleed on the surface of the roller body to contaminate the photosensitive body or the toner or soil the paper.

The blending ratio of the ion-conductive elastomer constituting the ion-conductive resin antistatic agent is preferably not less than 50 parts by mass, particularly preferably not less than 70 parts by mass, and preferably not more than 150 parts by mass, particularly preferably not more than 120 parts by mass with respect to 100 parts by mass of the rubber component.

If the blending ratio of the ion-conductive elastomer is less than the above range, the aforementioned effect of stabilizing ions derived from the ion-conductive salt by the ion-conductive elastomer is not sufficiently attained but it may not be possible to supply excellent ion conductivity to the roller body. If the blending ratio of the ion-conductive elastomer exceeds the above range, on the other hand, no further effect of adding the ion-conductive elastomer may be attained.

The blending ratio of the ion-conductive salt is preferably not less than 0.1 parts by mass, particularly preferably not less than 1 part by mass, and preferably not more than 10 parts by mass, particularly preferably not more than 5 parts by mass with respect to 100 parts by mass of the rubber component.

If the blending ratio of the ion-conductive salt is less than the above range, it may not be possible to supply excellent ion conductivity to the roller body. If the blending ratio of the ion-conductive salt exceeds the above range, on the other hand, not only no further effect of adding the ion-conductive salt is attained but also an excess part of the ion-conductive salt may bloom or bleed on the surface of the roller body, to contaminate the surface of the photosensitive body or the image carrier.

The blending ratio of the solubilizer is preferably not less than 1 part by mass, particularly preferably not less than 5 parts by mass, and preferably not more than 20 parts by mass, particularly preferably not more than 10 parts by mass with respect to 100 parts by mass of the rubber component.

If the blending ratio of the solubilizer is less than the above range, the function of the solubilizer is so insufficient that the ion-conductive elastomer cannot be finely dispersed into the resin matrix but may be separated into strips on a surface layer portion of the roller body along the extrusion direction in the extrusion molding.

If the blending ratio of the solubilizer exceeds the above range, on the other hand, not only no further effect of adding the solubilizer is attained but also the strength of the roller body may be reduced or the hardness thereof may be increased.

When dynamically crosslinking the ion-conductive elastomer, the blending ratio of the peroxidic crosslinking agent is preferably not less than 0.1 parts by mass, particularly preferably not less than 0.1 parts by mass, and preferably not more than 10 parts by mass, particularly preferably not more than 5 parts by mass with respect to 100 parts by mass of the ion-conductive elastomer.

If the blending ratio of the peroxidic crosslinking agent is less than the above range, the ion-conductive elastomer is so insufficiently crosslinked that the aforementioned crosslinking effect is not sufficiently attained. If the blending ratio of the peroxidic crosslinking agent exceeds the above range, on the other hand, the mechanical characteristics are reduced due to cutting of molecules or defective dispersion is caused to result in difficulty in working.

The blending ratio of the crosslinking assistant is preferably not less than 0.1 parts by mass, and preferably not more than 10 parts by mass, particularly preferably not more than 5 parts by mass with respect to 100 parts by mass of the ion-conductive elastomer.

The blending ratio of the filler is preferably not less than 10 parts by mass, particularly preferably not less than 20 parts by mass, and preferably not more than 100 parts by mass, particularly preferably not more than 50 parts by mass with respect to 100 parts by mass of the rubber component.

If the blending ratio of the filler is less than the above range, it may not be possible to sufficiently attain the effect of increasing the mechanical strength of the roller body by blending the filler. If the blending ratio of the filler exceeds the above range, on the other hand, the flexibility of the roller body may be reduced.

When not less than two types of fillers are employed together as the filler, the blending ratio corresponds to the total blending ratio of the fillers.

In order to prepare the thermoplastic elastomer composition, a kneaded substance is first prepared by dispersing the crosslinked substance of the rubber composition into the resin matrix.

When utilizing the dynamic crosslinking, for example, the kneaded substance is obtained by heating and kneading a mixture obtained by blending the resin crosslinking agent, the crosslinking assistant (the crosslinking activator), the softener and the like into the resin matrix and the rubber component not yet crosslinked and dynamically crosslinking the mixture while finely dispersing the rubber component into the resin matrix, as hereinabove described.

The mixture can be kneaded in an extruder, a Banbury mixer or a kneader, and the extruder is particularly preferable. When employing the extruder, the kneaded substance can be prepared by kneading the mixture while continuously heating the same and dynamically crosslinking the rubber component in a screw portion of the extruder and the kneaded substance can be successively extruded from the forward end of a nozzle to be continuously fed to a subsequent step (a pelletizing step or the like, for example), whereby the productivity of the kneaded substance can be improved.

The rubber component is preferably dynamically crosslinked in the presence of halogen. In this case, a halogenated resin crosslinking agent may be employed. Further, a halogen-donative substance such as stannous chloride, ferric chloride or cupric chloride may be added.

Then, the thermoplastic elastomer composition is prepared by heating and kneading a mixture obtained by mixing the ion-conductive resin antistatic agent prepared by kneading the ion-conductive salt into the ion-conductive elastomer and the aforementioned kneaded substance as well as the solubilizer, the filler etc. if necessary thereby finely dispersing the ion-conductive resin antistatic agent into the matrix resin.

At this time, the peroxidic crosslinking agent and the crosslinking assistant may be blended into the mixture for dynamically crosslinking the same while finely dispersing the ion-conductive elastomer constituting the ion-conductive resin antistatic agent into the matrix resin.

Also in this case, the mixture can be kneaded in an extruder, a Banbury mixer or a kneader, and the extruder is particularly preferable. When employing the extruder, the thermoplastic elastomer composition can be prepared by kneading the mixture while continuously heating the same in a screw portion of the extruder and the thermoplastic elastomer composition can be successively extruded from the forward end of a nozzle to be continuously fed to the subsequent step (the pelletizing step or the like, for example), whereby the productivity of the thermoplastic elastomer composition can be improved.

Thereafter the roller body is manufactured by supplying the prepared thermoplastic elastomer composition to an extrusion molder for extrusion-molding the cylindrical body for forming the roller body and cylindrically extrusion-molding the thermoplastic elastomer composition through a mouthpiece of a die connected to the forward end of a screw portion of the extrusion molder.

The conditions for the extrusion molding may be similar to those in the prior art. For example, the extrusion temperature (a set temperature on the forward end of the screw portion) is preferably not less than 160° C., particularly preferably not less than 180° C., and preferably not more than 250° C., particularly preferably not more than 230° C. The extrusion speed is preferably not less than 0.5 m/min., particularly preferably not less than 0.8 m/min., and preferably not more than 7 m/min., particularly preferably not more than 5 m/min.

The mixture of the ion-conductive resin antistatic agent, the kneaded substance, the solubilizer, the filler etc. may be directly supplied to the extrusion molder, to be kneaded and extrusion-molded in the screw portion of the extrusion molder. The conditions for the extrusion molding may be generally equivalent to the above.

(Conductive Roller and Electrophotographic Apparatus)

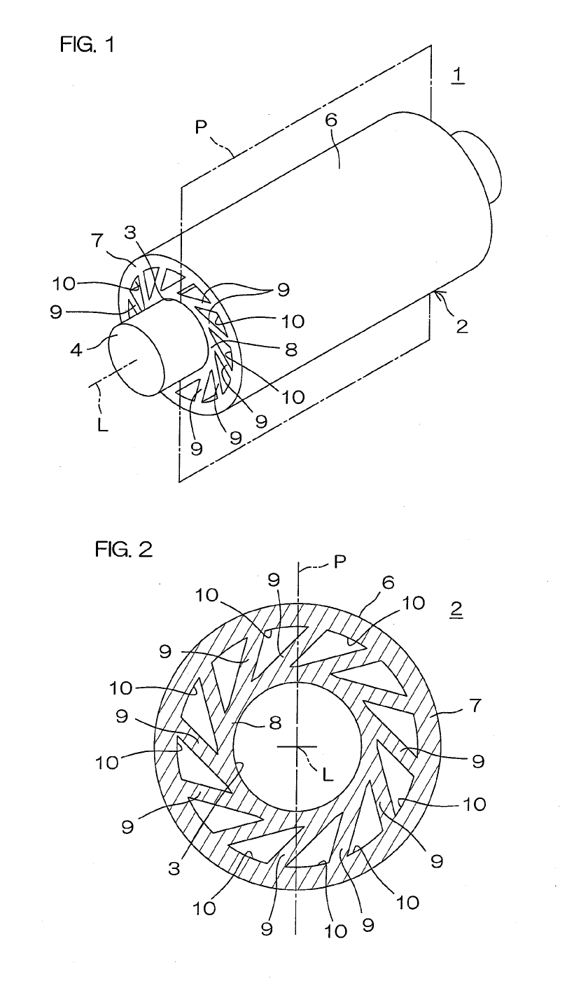

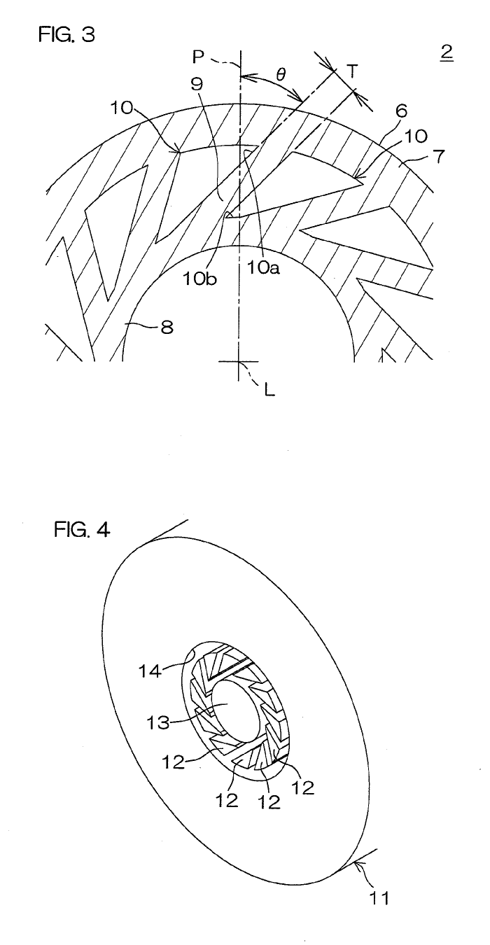

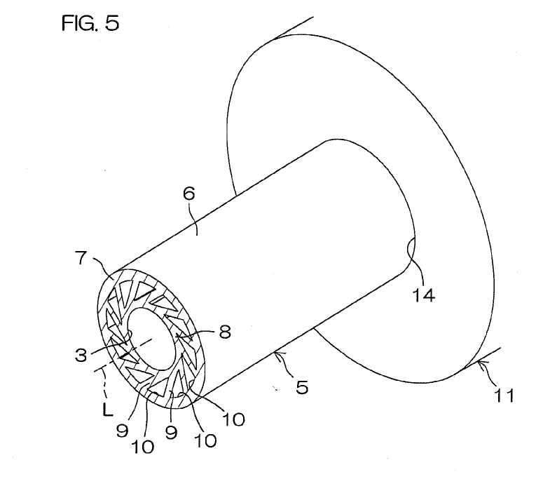

FIG. 1 is a perspective view showing the whole of a conductive roller according to an embodiment of the present invention. FIG. 2 is a sectional view of a roller body included in the conductive roller shown in FIG. 1. FIG. 3 is a sectional view partially showing the roller body in an enlarged manner. FIG. 4 is a perspective view showing a mouthpiece of a die employed for forming the roller body by extrusion molding. FIG. 5 is a perspective view illustrating a step of forming the roller body by extrusion molding with the die having the mouthpiece shown in FIG. 4.

Referring to FIG. 1, a conductive roller 1 according to the embodiment includes a cylindrical roller body 2 made of the thermoplastic elastomer composition or the like and a shaft 4 inserted into a through-hole 3 at the center of the roller body 2. The roller body 2 is formed by cutting a cylinder 5 (see FIG. 5) formed by extrusion-molding the thermoplastic elastomer composition, for example, into a prescribed length.

Referring to FIGS. 1 to 3, the roller body 2 includes a solid outer cylinder 7 constituting an outer peripheral surface 6 of the roller body 2 and a solid inner cylinder 8, having an outer diameter smaller than the inner diameter of the outer cylinder 7, arranged in the outer cylinder 7.

The outer cylinder 7 and the inner cylinder 8 are coupled with each other by a plurality of coupling portions 9 reaching the inner periphery of the outer cylinder 7 from the outer periphery of the inner cylinder 8, to be concentrically arranged while matching central axes L thereof with each other. The outer cylinder 7, the inner cylinder 8 and the coupling portions 9 are integrally formed by the aforementioned thermoplastic elastomer composition by the extrusion molding.

A plurality of hollow portions 10 separated from one another by the coupling portions 9 are provided between the outer periphery of the inner cylinder 8 and the inner periphery of the outer cylinder 7.

According to the embodiment, 12 coupling portions 9 and 12 hollow portions 10 are arranged at regular intervals in the circumferential direction of the roller body 2 respectively, to surround the through-hole 3.

Each coupling portion 9 is in the form of a flat plate extending over the total length of the roller body 2. Each coupling portion 9 is arranged to intersect with a plane P, passing through the central axes L of the outer cylinder 7 and the inner cylinder 8, so that the adjacent pair of hollow portions 10 separated from each other by the coupling portion 9 overlap with each other inwardly and outwardly in the radial direction of the roller body 2.

Referring to the two hollow portions 10 positioned uppermost in FIGS. 2 and 3, the coupling portion 9 therebetween is arranged to intersect with the plane P so that the hollow portion 10 mostly positioned on the left side of the plane P partially (10a in FIG. 3) protrudes rightward beyond the plane P on the upper side (the outer side in the radial direction, i.e., the side closer to the outer cylinder 7) in FIGS. 2 and 3.

On the other hand, the hollow portion 10 mostly positioned on the right side of the plane P partially (10b in FIG. 4) protrudes leftward beyond the plane P on the lower side (the inner side in the radial direction, i.e., the side closer to the inner cylinder 8) in FIGS. 2 and 3.

Consequently, the hollow portions 10 overlap with each other on the plane P inwardly and outwardly in the radial direction of the roller body 2.

The remaining coupling portions 9 are also arranged to intersect with the corresponding planes P, so that similar relations hold also as to the remaining coupling portions 9 and the remaining hollow portions 10.

Thus, the hollow portions 10 are necessarily present over the entire periphery of the roller body 2, and the flexibility of the roller body 2 can be rendered generally constant as a whole over the entire periphery in the circumferential direction due to the action of the hollow portions 10. In addition, the flexibility of the roller body 2 can also be improved as a whole due to the plurality of hollow portions 10 provided therein.

Therefore, when the conductive roller 1 including the roller body 2 is used as a transfer roller, for example, an image formed on the surface of a paper can be reliably prevented from nonuniformity or the like particularly under low-temperature conditions.

In the section shown in FIG. 2 orthogonal to the central axis L of the roller body 2, an area proportion of the hollow portions 10 obtained from the total sectional area of the hollow portions 10 and the sectional area of the remaining solid portions according to the following equation (1) is preferably not less than 10%, particularly preferably not less than 15%, and preferably not more than 80%, particularly preferably not more than 70%:

area proportion(%)=(sectional area of hollow portion)/(sectional area of hollow portion)+(sectional area of solid portion)×100 (1)

If the area proportion is less than the above range, no effect of providing excellent flexibility to the whole roller body 2 is attained by providing the hollow portions 10. When the conductive roller 1 is used as a transfer roller, for example, the transfer roller cannot be brought into contact with a photosensitive body or an image carrier with a prescribed nip width in this case, and hence it may not be possible to form an excellent image on the surface of a paper.

If the area proportion exceeds the above range, on the other hand, it is not easy to manufacture the roller body 2 by extrusion molding or the like.

Referring to FIGS. 4 and 5, the roller body 2 including the aforementioned portions is formed by cutting the cylinder 5, formed by extrusion-molding the thermoplastic elastomer composition with an extrusion molder including a die provided with a plurality of pins (mandrels) 12 for forming the hollow portions 10 and a mandrel 13 for forming the through-hole 3 inside a mouthpiece 11, into the prescribed length.

The thermoplastic elastomer composition is extrusion-molded through openings between the pins 12 and the mandrel 13 in an inner peripheral surface 14 of the mouthpiece 11, whereby the hollow portions 10 corresponding to the pins 12 and the through-hole 3 corresponding to the mandrel 13 are formed in the cylinder 5.

In other words, the coupling portions 9 are formed by the portions of the thermoplastic elastomer composition extrusion-molded through the openings between the pins 12, the inner cylinder 8 is formed by the portion of the thermoplastic elastomer composition extrusion-molded through the opening between the pins 12 and the mandrel 13, and the outer cylinder 7 is formed by the portion of the thermoplastic elastomer composition extrusion-molded through the opening between the pins 12 and the inner peripheral surface 14 of the mouthpiece 11, while the hollow portions 10 and the through-hole 3 are provided between the coupling portions 9, the inner cylinder 8 and the outer cylinder 7.

The shaft 4 is rendered conductive, in order to constitute the conductive roller 1. The conductive shaft 4 can be integrally formed by a metal such as aluminum or an alloy thereof or stainless steel, for example. Alternatively, the shaft 4 can be made of ceramic or hard resin to have a composite structure provided with a conductive film or the like electrically connected with the roller body 2 on the outer peripheral surface thereof.

The outer peripheral surface 6 of the roller body 2 may be covered with a coating layer. The coating layer can be formed by applying a coating agent prepared by dispersing powder of fluororesin or the like into an emulsion or a solution of urethane resin or acrylic resin or a rubber latex and drying the same, for example. The outer peripheral surface 6 is covered with the coating layer to control the surface energy of the outer peripheral surface 6, thereby preventing the outer peripheral surface 6 from adhesion of paper dust or fixation of a toner and adjusting the coefficient of friction thereof.

The conductive roller 1 can be applied to a charging roller of an electrophotographic apparatus charging the surface of a photosensitive body in a charging step, a charging roller charging a toner while stirring the same in a toner charging process included in a developing step, a developer roller selectively bonding the charged toner to an electrostatic latent image on the surface of the photosensitive body and developing the same into a toner image in a process of bonding the toner to the electrostatic latent image, a transfer roller transferring the toner image to the surface of a paper or an image carrier in a transfer step, or a cleaning roller removing the residual toner in a cleaning step.

In particular, the conductive roller 1 is preferably used as the transfer roller directly coming into contact with the paper and hence easily causing various problems resulting from adhesion of paper dust.

When the conductive roller 1 is used as the transfer roller, the resistance value of the roller body 2 is preferably not less than about 10⁴Ω and not more than about 10⁹Ω, particularly preferably not less than about 10⁶Ω and not more than about 10⁹Ω with an applied voltage of 1000 V.

In order to adjust the resistance value in the above range, the types, the blending ratios etc. of the ion-conductive elastomer, the ion-conductive salt etc. may be properly adjusted in the aforementioned ranges, for example.

As to the hardness of the roller body 2 of the conductive roller 1, used as the transfer roller, in the direction of the central axis L from the outer peripheral surface 6, the spring type C hardness measured under conditions of a temperature of 23±1° C. and relative humidity of 55±1% according to the spring type C hardness testing method defined in Appendix 2, JIS K7312₋₁₉₉₆ “The Physical Testing Methods for Molded Products of Thermosetting Polyurethane Elastomers” is preferably not more than 55, particularly preferably not more than 40.

If the hardness of the roller body 2 is within the above range, the image formed on the surface of the paper can be reliably prevented from nonuniformity or the like particularly under low-temperature conditions when the conductive roller 1 is used as the transfer roller, by supplying excellent flexibility to the roller body 2. Further, the coefficient of friction with respect to the paper can be increased to hardly cause defective paper feeding or the like.

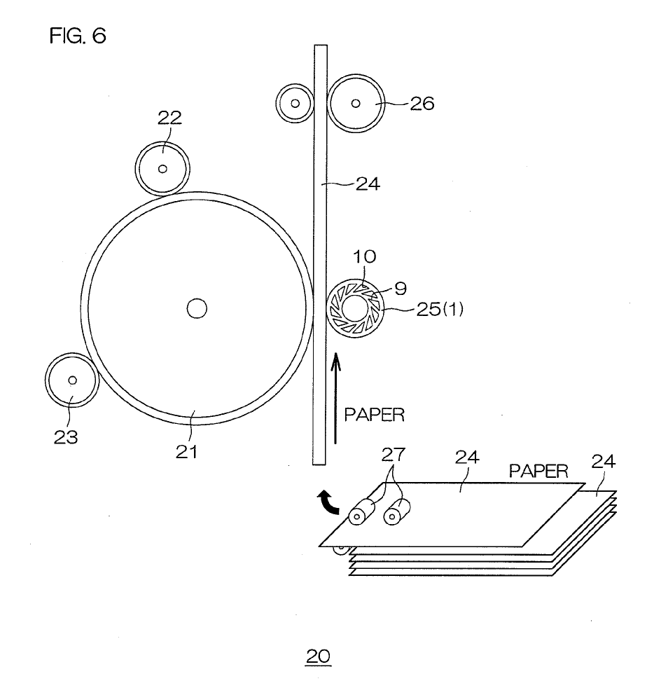

FIG. 6 is a schematic configuration diagram showing an electrophotographic apparatus according to an embodiment of the present invention.

An electrophotographic apparatus 20 of the according to the present invention includes a photosensitive drum 21, a charging roller 22 being in touch with a surface of the photosensitive drum 21 for charging the photosensitive drum 21, a development roller 23 being in touch with the surface of the photosensitive drum 21 for transferring toner to the surface of the photosensitive drum 21, a transfer roller 25 for transferring toner on the surface of the photosensitive drum 21 to the paper 24, a fuser roller 26 for fixing toner on the paper 24 to the paper 24 and a feed roller 27.

The electrophotographic apparatus 20 includes the conductive roller 1 according to the present invention built thereinto as the transfer roller 25, for example, whereby an excellent image can be uniformly formed on the surface of the paper 24 particularly under low-temperature conditions due to the function of the conductive roller (the transfer roller 25). The electrophotographic apparatus 20 can be applied to a laser printer, an electrostatic copier, a plain paper facsimile or a composite machine thereof.

The present invention is not restricted to the aforementioned embodiment.

For example, each coupling portion 9 is not restricted to the form of a flat plate, but may be in the form of an arbitrary plate such as a bent plate in which the portion between end portions closer to the inner cylinder 8 and the outer cylinder 7 respectively protrudes outward in the radial direction of the roller body 2.

The present invention may be embodied in other ways, within the range of the subject matter of the present invention.

### EXAMPLE

In each of the following Example and comparative examples, a conductive roller was manufactured and tested in an environment having a temperature of 23±1° C. and relative humidity of 55±1%, unless otherwise stated.

### Example 1

### Preparation of Thermoplastic Elastomer Composition

EPDM [Espren (registered trademark) EPDM505A by Sumitomo Chemical Co., Ltd.] as a rubber component, paraffinic oil [Diana (registered trademark) process oil PW-380 by Idemitsu Kosan Co., Ltd.], a resin crosslinking agent [brominated alkylphenol-formaldehyde resin, Tacky Roll (registered trademark) 250-III by Taoka Chemical Co., Ltd.] and zinc oxide [Zinc Oxide No. 1 by Mitsui Mining and Smelting Co., Ltd.] as a crosslinking assistant (a crosslinking activator) were blended into a hydrogenated styrene-based thermoplastic elastomer [SEEPS, Septon (registered trademark) 4077 by Kuraray Co., Ltd.] and polypropylene [Novatec (registered trademark) PP by Japan Polypropylene Corporation] as a resin matrix.

The components were heated to 200° C. and kneaded in a screw portion of a biaxial extruder for dynamically crosslinking the rubber component, extruded from the forward end of a nozzle, then continuously cut into a prescribed length and pelletized, thereby preparing a kneaded substance containing crosslinked EPDM dispersed into the resin matrix.

Further, an ion-conductive resin antistatic agent was prepared by blending bis(trifluoromethanesulfonyl)imide lithium as an ion-conductive salt and an EO-PO-AGE copolymer [Zeospan (registered trademark) 8010 by Nippon Zeon Co., Ltd.] at a mass ratio of 1:9 and kneading the same.

Then, the ion-conductive resin antistatic agent, the kneaded substance and an ethylene-acrylic ester-maleic anhydride copolymer [Bondine (registered trademark) LX4110 by Arkema Inc.] as a solubilizer were dry-blended in a tumbler, thereafter heated to 200° C. and kneaded in the screw portion of the biaxial extruder, extruded from the forward end of the nozzle, then continuously cut into a prescribed length and pelletized, thereby preparing a thermoplastic elastomer composition.

Table 1 shows the blending ratios of the components constituting the thermoplastic elastomer composition.

TABLE 1

| Component | Parts by Mass |
|---|---|
| EPDM | 100 |
| Hydrogenated | 50 |
| Styrene-Based | |
| Thermoplastic Elastomer | |
| Polypropylene | 20 |
| Paraffinic Oil | 100 |
| Resin Crosslinking Agent | 12 |
| Zinc Oxide | 5 |
| Solubilizer | 8 |
| Ion-Conductive Resin | 10 |
| Antistatic Agent | |

(Manufacturing of Conductive Roller)

The pellet of the thermoplastic elastomer composition was heated and kneaded in a screw portion of an extrusion molder and cylindrically extrusion-molded through a mouthpiece of a die connected to the forward end of the screw portion, thereby preparing a cylinder 5 for forming a roller body 2.

Two conditions, i.e., a low-speed condition of an extrusion temperature (on the forward end of the screw portion) of 200° C. and an extrusion speed of about 1 m/min. and a high-speed condition of the same extrusion temperature and an extrusion speed of about 3 m/min. were set for the extrusion molding.

The outer diameter of the cylinder 5 was set to 12.5 mm, and the inner diameter of a through-hole 3 was set to 4.6 mm.

A plurality of pins 12 and a mandrel 13 were provided inside a mouthpiece 11 as shown in FIGS. 4 and 5, thereby forming the through-hole 3 as well as 12 coupling portions 9 in the form of flat plates and 12 hollow portions 10 arranged around the through-hole 3 at regular intervals in the circumferential direction of the roller body 2, having sectional shapes shown in FIGS. 2 and 3 respectively, in the extrusion-molded cylinder 5.

Referring to the section shown in FIG. 3, the thickness T of each coupling portion 9 was set to 0.8 mm, and a crossing angle θ of the coupling portion 9 with respect to a plane P was set to 30°.

Each pair of hollow portions 10 adjacent to each other through each coupling portion 9 were overlapped with each other on the plane P inwardly and outwardly in the radial direction of the roller body 2 as shown in FIG. 3, by arranging the coupling portion 9 to intersect with the plane P and adjusting the thickness T and the crossing angle θ to the aforementioned values. Thus, the hollow portions 10 were necessarily present over the entire periphery of the roller body 2.

The area proportion of the hollow portions 10 obtained from the total sectional area of the hollow portions 10 and the sectional area of the remaining solid portions according to the above equation (1) was 30.4%.

The extrusion-molded cylinder 5 was cooled while the same was maintained unrotational on the central axis L thereof in the circumferential direction, and a shaft 4 was thereafter inserted into the through-hole 3. Then, the cylinder 5 was cut into a length of 216 mm to form the roller body 2, thereby manufacturing a conductive roller 1.

### Comparative Example 1

A cylinder 5 was extrusion-molded similarly to Example 1, except that no pins 12 were provided inside a mouthpiece 11 and hence no hollow portions 10 were formed in a roller body 2. The outer diameter of the cylinder 5 was set to 12.5 mm, and the inner diameter of a through-hole 3 was set to 4.6 mm.

The cylinder 5 was entirely solid with no hollow portions, and the area proportion of hollow portions obtained according to the above equation (1) was 0%.

Then, a roller body 2 was formed similarly to Example 1 except that the cylinder 5 was employed, thereby manufacturing a conductive roller 1.

### Comparative Example 2

A cylinder 5 having a sectional shape shown in FIG. 2(b) of parent Document 4 was extrusion-molded similarly to Example 1, except that eight pins each having a circular section were arranged around a mandrel 13 at regular intervals inside a mouthpiece 11. The outer diameter of the cylinder 5 was set to 12.5 mm, the inner diameter of a through-hole 3 was set to 4.6 mm, and the inner diameter of each hollow portion, having a circular section, corresponding to each pin was set to 1.3 mm.

In the cylinder 5, regions including the hollow portions and solid regions including no hollow portions were alternately present in the circumferential direction.

The area proportion of the hollow portions obtained from the total sectional area of the hollow portions and the sectional area of the remaining solid portions according to the above equation (1) was 10%.

A roller body 2 was formed similarly to Example 1 except that the cylinder 5 was employed, thereby manufacturing a conductive roller 1.

### Comparative Example 3

A cylinder 5 having a sectional shape shown in FIG. 2(c) of Patent Document 4 was extrusion-molded similarly to Example 1, except that 48 pins each having a circular section were arranged around a mandrel 13 in three concentric layers each having 16 pins at regular intervals in the circumferential direction inside a mouthpiece 11. The outer diameter of the cylinder 5 was set to 12.5 mm, the inner diameter of a through-hole 3 was set to 4.6 mm, and the inner diameter of each hollow portion, having a circular section, corresponding to each pin was set to 0.5 mm.

Also in the cylinder 5, regions including the hollow portions and solid regions including no hollow portions were alternately present in the circumferential direction.

The area proportion of the hollow portions obtained from the total sectional area of the hollow portions and the sectional area of the remaining solid portions according to the above equation (1) was 8.9%.

A roller body 2 was formed similarly to Example 1 except that the cylinder 5 was employed, thereby manufacturing a conductive roller 1.

### Comparative Example 4

A cylinder 5 having a sectional shape shown in FIG. 1 of Patent Document 3 with no mold releasing layer on an outer peripheral surface 6 thereof was extrusion-molded similarly to Example 1, except that 18 pins each having an oblong sectional shape were arranged around a mandrel 13 at regular intervals in the circumferential direction inside a mouthpiece 11. The outer diameter of the cylinder 5 was set to 12.5 mm, the inner diameter of a through-hole 3 was set to 4.6 mm, the sizes of the minor and major axes of each hollow portion, having an oblong section, corresponding to each pin were set to 1.0 mm and 2.0 mm respectively, and an angle formed by the major axis direction and a plane P was set to 30°.

Also in the cylinder 5, regions including the hollow portions and solid regions including no hollow portions were alternately present in the circumferential direction.

The area proportion of the hollow portions obtained from the total sectional area of the hollow portions and the sectional area of the remaining solid portions according to the above equation (1) was 26.6%.

A roller body 2 was formed similarly to Example 1 except that the cylinder 5 was employed, thereby manufacturing a conductive roller 1.

(Hardness Measurement)

In each of the conductive rollers 1 manufactured according to Example 1 and comparative examples 1 to 4, the hardness of the roller body 2 in the direction from the outer peripheral surface 6 toward the central axis L was measured according to the aforementioned spring type C hardness testing method defined in Appendix 2, JIS K7312₋₁₉₉₆ on the outer peripheral surface 6 every angle of 22.5° in the circumferential direction, to obtain the maximum and minimum values as well as the difference between the maximum and minimum values. The hardness of the roller body 2 in the circumferential direction is nonuniformized as the difference between the maximum and minimum values is increased.

(Image Evaluation Test)

Each of the conductive rollers manufactured according to Example 1 and comparative examples 1 to 4 was built into a laser printer [LaserJet (registered trademark) P1006 by Hewlett-Packard Japan, Ltd.] as a transfer roller, and halftone images were continuously printed on 20 standard typing papers [PPC papers by Fuji Xerox Office Supply Co., Ltd.] in a low-temperature environment having a temperature of 10° C. and relative humidity of 20±1%.

Then, the 20 papers were visually observed to evaluate the qualities of the images under the low-temperature condition as follows:

◯: No defective images with nonuniformity or moirés were included in the 20 papers.

X: Generally all 20 images were defective with obvious nonuniformity or moirés.

Table 2 shows the results.

TABLE 2

| | | | | Comp. | Comp. | Comp. | Comp. |
|---|---|---|---|---|---|---|---|
| | | | Ex. 1 | Ex. 1 | Ex. 2 | Ex. 3 | Ex. 4 |
| Hollow | Presence | | yes | no | yes | yes | yes |
| Portion | Overlap | | yes | no | no | no | no |
| | Area | | 30.4 | 0 | 10 | 8.9 | 26.6 |
| | Proportion (%) | | | | | | |
| Evaluation | Type | Maxi- | 54 | 73 | 73 | 70 | 64 |
| | C | mum | | | | | |
| | Hard- | Value | | | | | |
| | ness | Mini- | 52 | 72 | 65 | 61 | 58 |
| | | mum | | | | | |
| | | Value | | | | | |
| | | Differ- | 2 | 1 | 8 | 9 | 6 |
| | | ence | | | | | |

| | | | | | |
|---|---|---|---|---|---|
| Image | ∘ | x | x | x | x |
| Evaluation | | | | | |

It has been recognized from Table 2 that the conductive roller according to comparative example 1, entirely rendered solid with no hollow portions provided in the roller body, was only slightly dispersed in hardness but excessively hard as a whole, and hence particularly a central portion of the roller body was so insufficiently in contact with the papers in the low-temperature environment that defects of vertical lines were caused at the central portions of the images.

It has also been recognized that, in each of the conductive rollers according to comparative examples 2 to 4 provided therein with the hollow portions not overlapped with one another, the difference in hardness between the regions including the hollow portions and the solid regions including no hollow portions was so remarkable that defects such as nonuniformity in image density or moirés, i.e., strong nonuniformity, were caused in the low-temperature environment.

On the other hand, it has been recognized that the conductive roller according to Example 1, provided therein with the hollow portions 10 in adjacently overlapped states so that the hollow portions 10 were necessarily present over the entire periphery of the roller body 2, was soft as a whole and had a small difference in hardness, and hence it was possible to form excellent images with no defects such as nonuniformity or moirés in the low-temperature environment.

While the present invention has been described in detail by way of the embodiments thereof, it should be understood that these embodiments are merely illustrative of the technical principles of the present invention but not imitative of the invention. The spirit and scope of the present invention are to be limited only by the appended claims.

This application corresponds to Japanese Patent Application No. 2009-280820 filed with the Japan Patent Office on Dec. 10, 2009, the disclosure of which is incorporated herein by reference.

What is claimed is:

1. A conductive roller comprising:
a roller body made of a thermoplastic elastomer composition supplied with conductivity having:
an outer cylinder constituting an outer peripheral surface of the roller body;
an inner cylinder, having an outer diameter smaller than the inner diameter of the outer cylinder, concentrically arranged in the outer cylinder; and
a plurality of platelike coupling portions reaching the inner periphery of the outer cylinder from the outer periphery of the inner cylinder, wherein
a plurality hollow portions separated from one another by the coupling portions are provided between the outer periphery of the inner cylinder and the inner periphery of the outer cylinder, and
each coupling portion is arranged to intersect with a plane passing through the central axes of the outer cylinder and the inner cylinder so that adjacent hollow portions separated from each other by the coupling portion overlap with each other on the plane inwardly and outwardly in the radial direction in a section of the roller body in a direction orthogonal to the axial direction.

2. The conductive roller according to claim 1, wherein
the thermoplastic elastomer composition is supplied with conductivity by dispersing:
a crosslinked substance of at least one rubber component selected from a group consisting of diene rubber and ethylene propylene rubber, and
an ion-conductive resin antistatic agent into a resin matrix containing a styrene-based thermoplastic elastomer and polypropylene.

3. The conductive roller according to claim 2, wherein
the ion-conductive resin antistatic agent contains an ion-conductive elastomer and an ion-conductive salt.

4. An electrophotographic apparatus comprising:
a conductive roller including:
a roller body made of a thermoplastic elastomer composition supplied with conductivity having:
an outer cylinder constituting an outer peripheral surface the roller body;
an inner cylinder, having an outer diameter smaller than the inner diameter of the outer cylinder, concentrically arranged in the outer cylinder; and
a plurality of platelike coupling portions reaching the inner periphery of the outer cylinder from the outer periphery of the inner cylinder, wherein
a plurality hollow portions separated from one another by the coupling portions are provided between the outer periphery of the inner cylinder and the inner periphery of the outer cylinder, and
each coupling portion is arranged to intersect with a plane passing through the central axes of the outer cylinder and the inner cylinder so that adjacent hollow portions separated from each other by the coupling portion overlap with each other on the plane inwardly and outwardly in the radial direction in a section of the roller body in a direction orthogonal to the axial direction.

5. The electrophotographic apparatus according to claim 4, wherein
the thermoplastic elastomer composition is supplied with conductivity by dispersing:
a crosslinked substance of at least one rubber component selected from a group consisting of diene rubber and ethylene propylene rubber, and
an ion-conductive resin antistatic agent into a resin matrix containing a styrene-based thermoplastic elastomer and polypropylene.

6. The electrophotographic apparatus according to claim 5, wherein
the ion-conductive resin antistatic agent contains an ion-conductive elastomer and an ion-conductive salt.
